(19) United States
(12) Patent Application Publication
(10) Pub. No.: US 2018/0157834 A1
(43) Pub. Date: Jun. 7, 2018

(54) PROTECTION SYSTEM AND METHOD FOR PROTECTING A COMPUTER SYSTEM AGAINST RANSOMWARE ATTACKS

(71) Applicant: POLITECNICO DI MILANO, Milano (IT)

(72) Inventors: Andrea Continella, San Giovanni La Punta (IT); Stefano Zanero, Milano (IT); Federico Maggi, Vimercate (IT); Alessandro Guagnelli, Cesena (IT); Giovanni Zingaro, Milano (IT); Alessandro Barenghi, Cerano (IT); Giulio De Pasquale, Manduria (IT)

(21) Appl. No.: 15/368,465

(22) Filed: Dec. 2, 2016

(51) Int. Cl. G06F 21/55; G06F 17/30

(52) U.S. Cl. CPC G06F 21/554; G06F 17/3007; G06F 17/3012

(57) ABSTRACT

A protection system and a protection method for protecting a computer system against ransomware attacks is provided. The system and method effectively detect the effects of ransomware attacks by combining automatic detection and transparent file-recovery capabilities at the filesystem level.

### BACKGROUND

### Field of the Invention

The present invention relates to a protection system and a protection method for protecting computer system against ransomware attacks.

### Background of the Invention

As known, ransomware is a class of malware that encrypts valuable files found on the victim's computer system and asks for a ransom to release the decryption key(s) needed to recover the original files.

The requested ransom payment is typically in the order of a few hundred US dollars. Clearly, the success of these attacks depends on whether most of the victims agree to pay.

Unfortunately, it is known that about fifty percent of ransomware victims had surrendered to the extortion scheme, resulting in millions of dollars of illicit revenue.

From a technical viewpoint, ransomware malware families are now quite advanced. While first-generation ransomware were cryptographically weak, the recent families encrypt each file with a unique symmetric key protected by public-key cryptography. Consequently, the chances of a successfully recovery (without paying the ransom) have drastically decreased.

Kharraz et al. (Cutting the Gordian Knot: A Look Under the Hood of Ransomware Attacks, DIMVA 2016) were the first to analyze a large corpus of ransomware samples.

The authors suggest that the filesystem is a strategic point for monitoring the typical ransomware activity.

However, the authors do not disclose how to create a future-proof filesystem that transparently prevents the effects of ransomware attacks on the data.

Furthermore, Kharraz et al. (UNVEIL: A Large-Scale, Automated Approach to Detecting Ransomware, USENIX Security 2016) and Scaife et al (CryptoLock (and Drop It): Stopping Ransomware Attacks on User Data, IEEE ICDCS 2016) published two ransomware-detection approaches, respectively UNVEIL and CryptoDrop.

Although they both look at the filesystem layer to spot the typical ransomware activity, they do not combine it with a recovery capability: a false negative means that files are lost.

Also, their approaches do not include identification of cryptographic primitives.

Therefore, there is the need of a forward-looking filesystem that transparently and efficiently prevents the effects of ransomware attacks on the data.

Furthermore, documents U.S. Pat. No. 9,292,687 B2 and U.S. Pat. No. 9,317,686 B1 disclose known solutions for detecting malware attack, while US 2002/0178374 A1 discloses a method and apparatus for protecting data from damages using a rollback system.

### OBJECT OF THE INVENTION

The main aim of the present invention is to devise a protection system and a protection method for protecting computer system against ransomware attacks which effectively detect the effects of ransomware attacks.

Another object of the present invention is to devise a protection system and a protection method for protecting computer systems against ransomware attacks, which combines automatic detection and transparent file-recovery capabilities at the filesystem level.

### BRIEF DESCRIPTION OF THE DRAWINGS

Other characteristics and advantages of the present invention will appear better evident from the description of a preferred, but not exclusive, embodiment of a protection system and a protection method for protecting computer system against ransomware attacks, illustrated by way of an indicative, but non-limiting, example in the accompanying drawings, wherein:

FIG. 1 illustrates a high-level view of the protection system 1 according to the invention;

FIG. 2 illustrates an architectural description of the protection system according to the invention;

FIG. 3 shows a table with details of the numerical filesystem-activity features used by a detector module of the protection system according to the invention;

FIG. 4 illustrates an example of use of incremental models; and

FIG. 5 illustrates an example of detection routine of the protection system according to the invention.

### DETAILED DESCRIPTION OF THE PREFERRED EMBODIMENT

The protection system 1 according to the invention is able to detect malicious, ransomware-like activities at runtime and transparently recover all original files.

Specifically, the protection system 1 makes the Microsoft Windows native filesystem (and other filesystems that operate similarly) immune to ransomware attacks.

Particularly, for each running process, the protection system 1 dynamically toggles a protection layer that acts as a copy-on-write mechanism, according to the outcome of its detection component.

Internally, the protections system 1 monitors the low-level filesystem activity to update a set of adaptive machine-learning models that profile the system activity over time.

Whenever the filesystem activity of one or more processes violates these models, their operations are deemed malicious and the side effects on the filesystem are transparently rolled back.

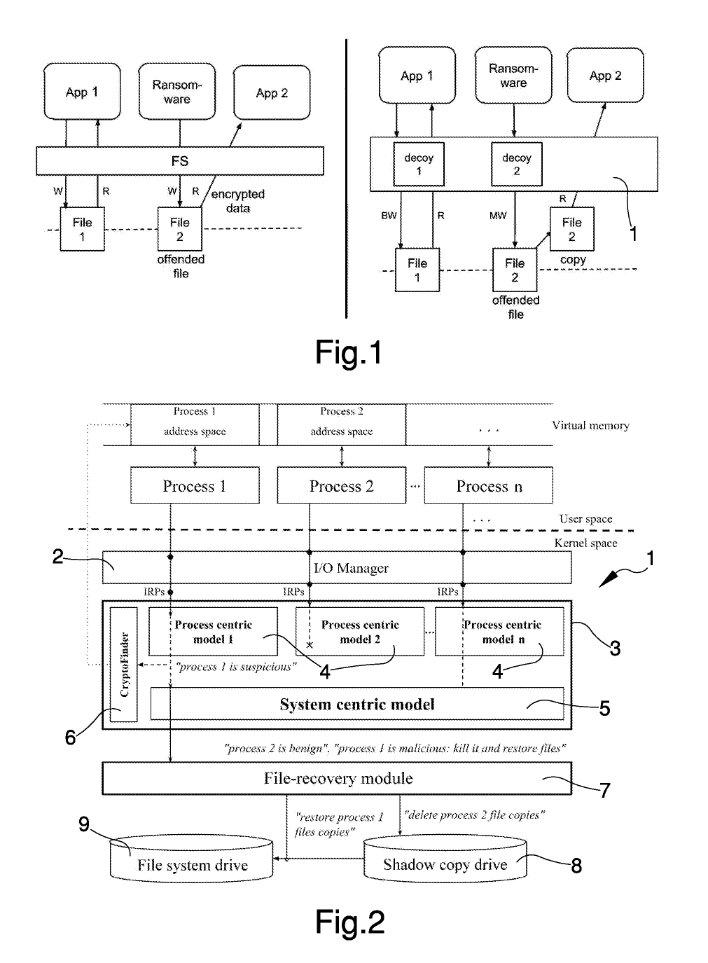

FIG. 1 provides a high-level view of the protection system 1 according to the invention.

Particularly, the left side of FIG. 1 schematizes the functioning of a standard filesystem FS, wherein a ransomware attack is performed and file (File 2) is encrypted.

On the right side of FIG. 1 it is showed the protection system 1 according to the invention shadowing a file offended by ransomware malicious write (MW).

The protection system is positioned within a modern filesystem.

The “decoy” files are virtual copies of the original files that are used by the protection system 1 to monitor the filesystem activity of each user-space application (i.e., process), and derive a plurality of predefined features.

It is pointed out that the particular embodiment of the protection system 1 here below disclosed refers to Microsoft Windows system because it is the main target of the vast majority of ransomware families. However, the approach of the protection system according to the invention does not require any special filesystem nor OS support. Thus, the protection system could be ported to other platforms with modest engineering work.

FIG. 2 provides an architectural description of the protection system 1.

The protection system 1 collects I/O request packets IRPs from the filesystem layer of an operating system. IRPs are the smallest unit of exchange between user-space applications and the filesystem (e.g., as a result of a “read file” operation, thousands if not millions of IRPs are sent to the filesystem, which executes them to actualize the operation on the disk).

Particularly, the protection system 1 comprises an I/O manager 2 for IRPs from the filesystem layer.

Preferably, the protection system 1 interacts with the I/O manager 2 of the operating system (e.g. Windows) for intercepting IRPs from the filesystem layer.

The core of the I/O manager 2 is a minifilter driver that intercepts the IRPs generated for each filesystem primitive invoked by userland code (e.g., CreateFile, WriteFile, ReadFile referring to the Windows API).

Moreover, the I/O manager 2 enriches the raw IRPs with data including timestamp, entropy of write operations of the requesting process and PID.

It is pointed out that, although the concept of IRP is a common terminology for the Microsoft Windows operating system, other filesystems use concepts similar to IRPs (minor technical details apart). Therefore, the use of the protection system 1 according to the invention with different operating systems is not excluded.

Furthermore, the protection system 1 comprises a ransomware-activity detector module 3 for the automatic detection of ransomware activities as a function of the intercepted IRPs and based on the combined analysis of predefined filesystem-activity features.

Particularly, from the reading of the IRPs, which contain information about the process that is requesting the I/O operation, target file, content, and so on, the detector module 3 derives a plurality of numerical filesystem-activity features, comprising: entropy of write operations, frequency of read operations, frequency of write operations, folder-listing operations, dispersion of per-file writes, fraction of files renamed (with reference to all the files existing on the filesystem), and file-type usage statistics.

More details on these features are showed in FIG. 3.

Particularly, the detector module 3 comprises at least an updating process for updating the values of said filesystem-activity features as a function of said intercepted IRPs.

According to a preferred embodiment, to intercept the IRPs, the detector module 3 registers callback functions through a filter manager APIs (i.e., FltRegisterFilter).

For each IRP, the called function updates the filesystem-activity feature values, using separate kernel worker threads for computation-intensive functions (e.g., entropy calculation).

The filesystem-activity feature values are normalized according to statistics of the file system (e.g., total number of files, total number of folders). This normalization is useful to adapt the protection system 1 to different scenarios and usage habits. The rightmost column of the table in FIG. 3 shows a comparison of benign vs. ransomware program activity by means of the empirical cumulative distribution.

To keep the feature values normalized (e.g., number of files read, normalized by the total number of files), the first time the protection system 1 is run, a preliminary filesystem scanning process scans the filesystem to collect file extensions, number of files per extensions, and overall number of files.

Since the normalization factors change over time (i.e., new, deleted, or renamed files), the detector module comprises a statistics-updating process for updating the statistics of the filesystem.

According to a first solution, a dedicated kernel thread is used to update the normalization factors in real time.

According to a second solution, the protection system 1 updates the normalization factors periodically (e.g., once a day). In this way, even if an attacker tries to manipulate our normalization factors, them would need to wait until the next update before starting to access files without triggering any of the features.

The detector module 3 is a custom machine-learning classifier trained on the filesystem-activity features defined in FIG. 3, extracted from a large corpus of IRP logs obtained from clean and infected machines. Once trained, this classifier is leveraged at runtime to decide whether the features extracted from a live system fit the learned feature distributions (i.e., no signs of malicious activity) or not.

The detector module 3 keeps track of the filesystem-activity feature values in the long-term and short-term horizon, and cast a final decision based on both data.

Particularly, the detector module 3 uses automatically created detection models 4, 5 that distinguish ransomware from benign processes at runtime. The detector module 3 adapts the detection models to the system usage habits observed on the protected system.

As known, a malware can perform all its malicious actions on a single process, or split it across multiple processes (for higher efficiency and lower accountability). For this reason, the detector module adopts several detection models.

Particularly, the detector module 3 uses a first set of detection models 4, called process-centric models, each trained for the analysis of IRPs coming from each single process.

Furthermore, the detector module 3 use a second detection model 5, called system-centric model, trained by considering all the I/O request packets coming from all the processes of the whole system.

The rationale is that the system-centric model 5 has a good recall for multi-process malware, but has potentially more false positives.

For this reason, the system-centric model 5 is used only in combination to the process-centric models 4.

Furthermore, since the decision can change over time, all processes must be frequently and efficiently monitored.

To obtain an acceptable trade-off between speed and classification errors the detector module 3 adopts two orthogonal approaches.

First, instead of running each process-centric model 4 and the system-centric model 5 on the entire available process data, the detector module 3 splits the data in intervals (also called ticks).

Therefore, the process-centric models 4 and the system-centric model 5 of the detector module 3 are organized in a plurality of incremental, multi-tier models.

Ticks are defined with reference to the fraction of files accessed by the monitored process with respect to the total number of files in the system. In this way, the detection module 3 obtains an array of incremental, “specialized” models, each one trained on increasingly larger data intervals.

For instance, when a monitored process has accessed 2% of the files, the detector module queries the “2%-model” only, and so on.

This technique has a positive impact on efficiency, by reducing the number of IRPs required to cast a correct detection by three orders of magnitude, with a negligible impact on accuracy.

Secondly, to account for changes during a process' lifetime, the detector module keeps track of both the long-term and short-term history of each monitored process.

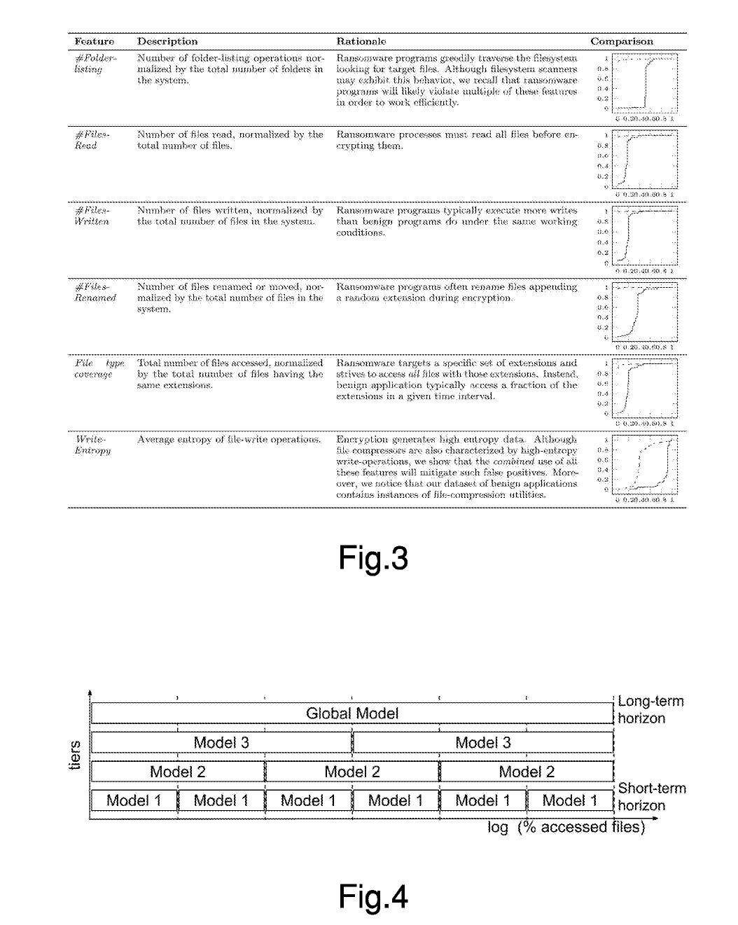

In practice, as illustrated in FIG. 4, the detector module 3 organizes the aforementioned incremental models in a multi-tier, hierarchical structure, with each tier observing larger spans of data.

At each tick, each tier analyzes the data up to N ticks in the past, where N depends on the tier level. The detector module 3 labels a process as “ransomware” as soon as all the tiers agree on the same outcome for K consecutive ticks.

The following example explains how the incremental, multi-tier models handle a typical case.

A benign process, e.g., Explorer, is running, and has accessed some files. After having analyzed the first i ticks worth of filesystem features the detector module will classify Explorer as benign.

Now, a ransomware process injects its code into Explorer's code region.

Referring to FIG. 4, if the ransomware process does code injection after the 3rd tick, the global-tier model classifies Explorer as benign, because the long-term feature values are not be affected significantly by the small, recent changes in the filesystem activity of Explorer.

Instead, the tier-1 model (immediately) identifies Explorer as malicious, because the tier-1 features are based only on the most recent IRPs (i.e., those occurring right after the code injection).

The same applies for tier-2 models after the 4th tick, and so on.

If K=3, for instance, and all the triggered tiers agree on a positive detection, the Explorer process is classified as malicious at this point in time. This decision, clearly, can change while more process history is examined.

According to a preferred embodiment of the detection module 3, each detection model (and classifier) 4, 5 is implemented as a random forest with 100 trees. Each tree outputs either −1 (benign) or +1 (malicious). The overall outcome of each process-centric model 4 is the sum of its trees' outcome, from −100 (highly benign) to 100 (highly malicious). In case of a tie (i.e., zero), the detector module 3 marks the monitored process as “suspicious” and invokes the system-centric model 5 to take the decision. In case of a second tie, the detector module 3 conservatively considers the process as “malicious”.

Different implementations are not excluded

Furthermore, according a preferred embodiment of the detection module 3, the protection system 1 gives more relevance to small variations in a feature value when a process has only accessed a few files. At the same time it minimizes the total number of models needed, thus containing the performance impact.

Particularly, the size of each tick grows exponentially with the percentage of files accessed by a process.

Preferably, 28 tiers are used, for intervals ranging from 0.1 to 100%, each one corresponding to a distinct model tier.

Adding other ticks beyond 28 would yield no improvements in detection rates, and would instead penalize the performance.

Furthermore, as showed in FIG. 1, the protection system 1 comprises a crypto-finder module 6 for cryptographic primitives detection.

As known, the most widespread, efficient symmetric-encryption algorithms of choice are fast block ciphers. These ciphers combine the plaintext with a secret key through a sequence of iterations, known as rounds. In particular, the key is expanded in a sequence of values, known as the “key schedule”, which is normally pre-computed for efficiency. All the mainstream cryptographic libraries and vast majority of ransomware families do pre-compute the key schedule. The entire key must remain materialized in memory during all the encryption procedure.

In order to detect cryptographic primitives, the crypto-finder module 6 comprises:
a scanning process for scanning the memory of the running process;
a checking process for checking, at every offset, whether the content of the memory can be obtained as a result of a key schedule computation.

Particularly, the scanning process and the checking process are implemented by means of appropriate software procedures.

The crypto-finder module 6 receives the PIDs of suspicious processes by the detector module, preferably through IOCTL (input/output control).

When triggered, the crypto-finder module 6 attaches to a process and obtains the list of its memory pages.

Specifically, the crypto-finder module 6 looks only at the committed pages, defined in Windows as the pages for which physical storage has been allocated either in memory or in the paging file on disk. Then, the crypto-finder module 6 runs the key-schedule algorithm on these memory regions and checks whether its expansion occurs.

For efficiency reasons, the crypto-finder module 6 stops the inspection of a location as soon as there is a single byte mismatch.

Furthermore, as showed in FIG. 1, the protection system 1 comprises a file-recovery module 7 provided with an automatic shadowing process for automatically creating a shadow copy of files of the filesystem whenever the original ones are modified.

The file-recovery module 7 approach is inspired by copy-on-write filesystems and is provided with an automatic shadowing process for automatically creating a shadow copy of a file on a shadow copy drive 8 whenever the original one on a filesystem drive 9 is modified, as depicted in FIG. 1.

Benign modifications are then cleared for space efficiency by a clearing process of the file-recovery module 7, and the net effect is that the user never sees the effects of a malicious file encryption program.

Preferably, the clearing process of the file-recovery module 7 clears benign modifications asynchronously.

The protection system 1 considers all the files as “decoys”, that is, it is assumed that the malware will reveal its behavior through such decoys because, indeed, it cannot avoid to access the files that it must encrypt to fulfill its goal.

The features defined in FIG. 3 summarize the I/O-level activity recorded on these decoys into quantitative indicators of compromise. Thus, the detection and file-recovery parts according to the protection-system approach are tightly coupled, in the sense that we rely on such decoys to both collect data for detection, and manage the shadowing of the original files.

Preferably, with reference to the specific embodiment disclosed and showed in the figures, the detector module 3 and the file-recovery module 7 are Windows minifilter drivers and the crypto-finder module 6 is a kernel driver.

Preferably, the file-recovery module 7 is implemented as a Windows minifilter driver that monitors file modifications by registering a callback for those IRP_MJ_CREATE operations which security context parameter Parameters.Create.SecurityContext indicates a “write” or “delete” I/O request. If the target file is not shadowed yet, the file-recovery module 7 creates a copy before letting the request through.

With the same technique, the file-recovery module 7 monitors the destination of (potentially malicious) file-renaming operations, by hooking the IRP_MJ_SET_INFORMATION requests having the ReplaceIfExists ag set. File handing and indexing in the shadow drive is based on the FILE_ID identifier assigned by NTFS to each file.

The file-recovery module 7 maintains a transaction log of the relevant IRPs (e.g., those resulting from file modifications). Whenever a process is classified as malicious, the file-recovery module 7 inspects such log and restores each file affected by the offending process.

File copies are deleted only when the processes that modified the original file have been classified as “benign”.

The file-recovery module 7 treats the shadow copy drive 8 as a cache: it avoids shadowing the same file if a fresh copy (i.e., not older than T hours) already exists.

Usefully, the protection system 1 maintains a whitelist of unimportant files for efficiency. In this case, the system can focus only on non-whitelisted files.

The protection method according to the invention is disclosed here below.

The protection method comprises at least the following steps:
intercepting I/O request packets (IRPs) from a filesystem layer of an operating system;
automatic detection of ransomware activities as a function of said intercepted IRPs and based on the combined analysis of predefined filesystem-activity features.

Particularly, the filesystem-activity features are selected from: entropy of write operations, frequency of read operations, frequency of write operations, folder-listing operations, dispersion of per-file writes, fraction of files renamed, and the file-type usage statistics.

The protection method comprises at least a step of updating the values of the filesystem-activity features as a function of the intercepted IRPs.

Furthermore, the method includes at least a step of normalization of the filesystem-activity feature values according to statistics of the filesystem, wherein said statistics of the filesystem comprise: file extensions, number of files per extensions, and overall number of files.

Particularly, the protection method comprises at least a step of preliminary scanning for collecting the statistics of the filesystem, and at least a step of updating said statistics of the filesystem, executed in real time or periodically.

Furthermore, the automatic detection step according to the method comprises an analysis of IRPs coming from a single process and an analysis of IRPs coming from all the processes of the whole system, wherein said analyses are performed in combination.

Particularly, said analyses are organized in a plurality of incremental, multi-tier step, each one performed on increasingly larger data intervals, wherein said data intervals are defined by the fraction of files accessed by the monitored process with respect to the total number of files in the system.

The protection method according to the invention further does optionally a crypto-finder step for cryptographic primitives detection comprising
scanning the memory of a running process;
checking, at every offset, whether the content of said memory of the running process can be obtained as a result of a key schedule computation.

Furthermore, the protection method according to the invention comprises at least an automatic shadowing step for automatically creating a shadow copy of files of the filesystem whenever the original ones are modified.

At least a clearing step is performed for clearing the shadow copies of files with benign modifications.

During the execution of the method, any newly created process enters a so-called “unknown” state.

Whenever such a process opens a file handle in write or delete mode for the first time (only), the file-recovery module 7 copies the file content in a trusted, read-only storage area. This storage can be on the main drive or on a secondary drive. In either case, the protection system 1 denies access to this area from any userland process by discarding any modification request coming from the upper I/O manager.

From this moment on, the process may read or write such file, while the detector module 3 monitors its activity.

When the protection system 1 has collected enough IRPs, the process goes into a “benign” “suspicious or “malicious” state.

File copies belonging to “benign” processes can be deleted immediately or, as file-recovery module 7 does, scheduled for asynchronous deletion. Since storage space is convenient nowadays, leaving copies available for an arbitrarily long time delay does not impose high costs. In turns, it greatly benefits the overall system performance because, by acting as a cache, it limits the number of copy operations required when the same files are accessed (and would need to be copied) multiple times.

For any process that enters the “malicious” state for at least one tick, the crypto-finder module 6 checks the presence of ciphers within the process.

If any are found, the protection system 1 immediately suspends the process and restores the offended files.

Otherwise, it waits until K positive ticks are detected by the detector module 3 before suspending the process, regardless of whether a traces of ciphers are found.

Processes can enter a “suspicious” state when the process-centric models 4 are not able to cast a decision. In this case, the detector module 3 queries the system-centric model 7. If it gives a positive outcome, then the process enters the “malicious” state. Otherwise the process is classified as “benign.”

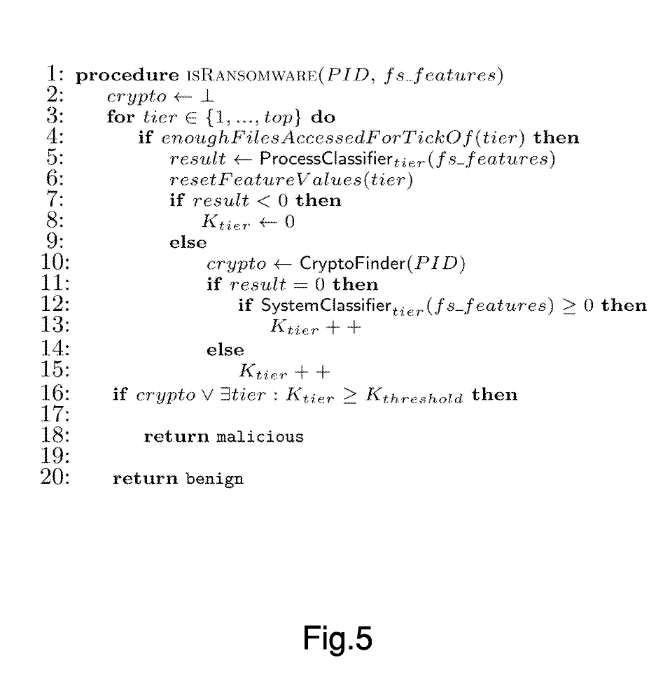

FIG. 5 illustrates an example of detection routine for each process, wherein “tier” refers to the hierarchical classifiers of FIG. 4, and Kₜᵢₑᵣ represents a counter for each tier.

It has in practice been ascertained how the described invention achieves the intended objects.

Particularly, the protection system allows to automatically create detection models that distinguish ransomware from benign processes at runtime. The protections system adapts these models to the filesystem usage habits observed on the protected system.

Additionally, the protection system looks for indicators of the use of cryptographic primitives. In particular, the crypto-finder module scans the memory of any process considered as potentially malicious, searching for traces of the typical block cipher key schedules.

A distinctive aspect of the protection system is how it copes with code injection, a common technique used by modern ransomware (as well as other malware). With code injection, a perfectly legitimate process suddenly executes malicious code.

The detection mechanism of the protection system takes into account both the long-term and the short-term history of each process, and of the entire system.

The protections system apply a detection approach in real-time, thus creating a self-healing virtual filesystem that conservatively shadows the write operations. Thus, if a file is surreptitiously altered by one or more malicious processes, the filesystem presents the original, mirrored copy to the user space applications. This shadowing mechanism is dynamically activated and deactivated depending on the outcome of the aforementioned detection logic.

What is claimed is:

1. A protection system for protecting a computer system against ransomware attacks, comprising:
an I/O manager for intercepting I/O request packets from a filesystem layer of an operating system; and
a ransomware activity detector module for the automatic detection of ransomware activities as a function of said intercepted I/O request packets and based on the combined analysis of predefined filesystem-activity features.

2. The protection system according to claim 1, wherein said filesystem-activity features are selected from: entropy of write operations, frequency of read operations, frequency of write operations, folder-listing operations, dispersion of per-file writes, fraction of files renamed, and file-type usage statistics.

3. The protection system according to claim 2, wherein said detector module comprises at least an updating process for updating the values of said filesystem-activity features as a function of said intercepted I/O request packets.

4. The protection system according to claim 1, wherein said filesystem-activity feature values are normalized according to statistics of the filesystem.

5. The protection system according to claim 1, wherein said detector module comprises at least a detection model for distinguishing a ransomware process from benign processes at runtime.

6. The protection system according to claim 5, wherein said at least a detection model comprises: at least a process-centric model for the analysis of I/O request packets coming from a single process and/or at least a system-centric model for the analysis of I/O request packets coming from all the processes of the whole system.

7. The protection system according to claim 6, wherein said at least a detection model comprises a plurality of incremental, multi-tier models, each one trained on increasingly larger data intervals.

8. The protection system according to claim 1, comprising a crypto-finder module for cryptographic primitives detection.

9. The protection system according to claim 8, wherein said crypto-finder module performs:
a scanning process for scanning the memory of a running process; and
a checking process for checking, at every offset, whether the content of said memory of the running process can be obtained as a result of a key schedule computation.

10. The protection system according to claim 1, comprising a file-recovery module provided with an automatic shadowing process for automatically creating a shadow copy of files of the filesystem whenever originals are modified.

11. The protection system according to claim 10, wherein said file-recovery module comprises an asynchronous clearing process for clearing the shadow copies of files with benign modifications.

12. A protection method for protecting a computer system against ransomware attacks, comprising at least the following steps:
intercepting I/O request packets from a filesystem layer of an operating system;
automatic detection of ransomware activities as a function of said intercepted I/O request packets and based on the combined analysis of predefined filesystem-activity features.

13. The protection method according to claim 12, wherein said filesystem-activity features are selected from: entropy of write operations, frequency of read operations, frequency of write operations, folder-listing operations, dispersion of per-file writes, fraction of files renamed, and file-type usage statistics.

14. The protection method according to claim 13, comprising at least a step of updating the values of said filesystem-activity features as a function of said intercepted I/O request packets.

15. The protection method according to claim 14, comprising at least a step of normalization of said filesystem-activity feature values according to statistics of the filesystem, wherein said statistics of the filesystem comprise: file extensions, number of files per extensions, and overall number of files.

16. The protection method according to claim 12, wherein said automatic detection step comprises: an analysis of I/O request packets coming from a single process and/or an analysis of I/O request packets coming from all the processes of the whole system.

17. The protection method according to claim 16, wherein said analyses are organized in a plurality of incremental, multi-tier step, each one performed on increasingly larger data intervals.

18. The protection method according to claim 12, comprising at least a crypto-finder step for cryptographic primitives detection.

19. The protection method according to claim 18, wherein said crypto-finder step comprises:
scanning the memory of a running process; and
checking, at every offset, whether the content of said memory of the running process can be obtained as a result of a key schedule computation.

20. The protection method according to claim 12, comprising at least an automatic shadowing step for automatically creating a shadow copy of files of the filesystem whenever originals are modified.
